(19) United States
(12) Patent Application Publication
(10) Pub. No.: US 2005/0132362 A1
(43) Pub. Date: Jun. 16, 2005

(54) Virtual machine management using activity information

(76) Inventors: Robert C. Knauerhase, Portland, OR (US); Vijay Tewari, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/733,177

(22) Filed: Dec. 10, 2003

(51) Int. Cl. G06F 9/455

(52) U.S. Cl. 718/1

(57) ABSTRACT

The present disclosure relates to the management of virtual machine(s) using information regarding the activity of the virtual machine(s), and, more specifically, to the reallocating of resources amongst virtual machine(s) based, at least in part, upon the activity of the virtual machine(s).

### BACKGROUND

1. Field

The present disclosure relates to the management of virtual machine(s) using information regarding the activity of the virtual machine(s), and, more specifically, to the reallocating of resources amongst virtual machine(s) based, at least in part, upon the activity of the virtual machine(s).

2. Background Information

The virtualization of machine resources has been of significant interest for some time; however, with processors becoming more diverse and complex, such as processors that are deeply pipelined/super pipelined, hyperthreaded, and processors having Explicitly Parallel Instruction Computing (EPIC) architecture, and with larger instruction and data caches, virtualization of machine resources is becoming an even greater interest. Some vendors offer software products that permit a machine to be partitioned, such that the underlying hardware of the machine appears as one or more independently operating virtual machines (VM). Typically, this is achieved by running a thin layer of software called the Virtual Machine Monitor (VMM) over the hardware which facilities running one or more VMs on this layer. The abstraction of a VM is such that the software installed inside the VM believes that is has exclusive ownership of the underlying hardware. Each VM, on the other hand, may function as a self-contained platform, running its own operating system (OS), or a copy of the OS, and/or various software applications. Software executing within a VM is collectively referred to as “guest software”.

A typical VMM, which may be considered the controller of the VMs, may enhance performance of a VM by permitting direct access to the underlying physical machine in some situations. This may be especially appropriate when an operation is being performed in non-privileged mode in the guest software, which limits access to the physical machine or when operations will not make use of hardware resources in the physical machine to which the VMM seeks to retain control. The VMM may swap guest software state in and out of the processor, devices, memory, and the registers of the physical machine, while the processor may swap some state in and out during transitions between a VM and the VMM.

The conventional allocation of resources by the VMM to the various VMs relies on time-slicing between various VMs according to round-robin or other predetermined priority-based schemes. For example, a pre-determined allocated time period (or time quanta) for each VM may be stored in the memory to direct the VMM to periodically switch between the VMs based on the previously allocated time period for each VM. Round-robin or pre-determined priority-based schemes inherently fail to provide the VMM any fine-grain control or authority regarding managing the VMs, as the VMM is limited to following the pre-determined plan or scheme. Stated differently, methods, apparatus, and systems, available today, are typically limited to round-robin or time-slicing of the VMs, and do not provide the VMM to intelligently swap between the VMs using processor state information including characteristics and/or history of the processor, characteristics and/or history of the guest software, characteristics and/or history of the VMs, and characteristics and/or history of the machine.

One solution proposed by VMWare, Inc. (VMWare) of Palo Alto, Calif., relies on OS thread-scheduling to use the VMM to swap between the VMs. The VMWare solution provides for running two or more operating systems, such as Linux and Microsoft Windows, on a single machine, using the facilities provided by the operating system that runs on the underlying hardware. This system relies on the OS scheduling policy to schedule the VMs. However, virtualization based on OS scheduling (for scheduling the VMs) is performed without the knowledge of the processor state or even the processor. Furthermore, as the VM functionality moves into hardware, the OS-based solutions that attempt to optimize context-switch intervals for processors will likely be less aware or even completely unaware of the processors, the underlying system and its behaviour. Furthermore, the OS-based solutions not only do not accommodate characteristics of different processors, but also do not accommodate characteristics of processors of a single family.

### BRIEF DESCRIPTION OF THE DRAWINGS

Subject matter is particularly pointed out and distinctly claimed in the concluding portions of the specification. The disclosed subject matter, however, both as to organization and the method of operation, together with objects, features and advantages thereof, may be best understood by a reference to the following detailed description when read with the accompanying drawings in which:

FIG. 1 is a flowchart illustrating an embodiment of a technique for reallocating resources amongst virtual machine(s) in accordance with the disclosed subject matter; and

FIG. 2 is a block diagram illustrating an embodiment of a system and apparatus that allows for management of virtual machine(s) using information regarding the activity of the virtual machine(s) in accordance with the disclosed subject matter.

### DETAILED DESCRIPTION

In the following detailed description, numerous details are set forth in order to provide a thorough understanding of the present disclosed subject matter. However, it will be understood by those skilled in the art that the disclosed subject matter may be practiced without these specific details. In other instances, well-known methods, procedures, components, and circuits have not been described in detail so as to not obscure the disclosed subject matter.

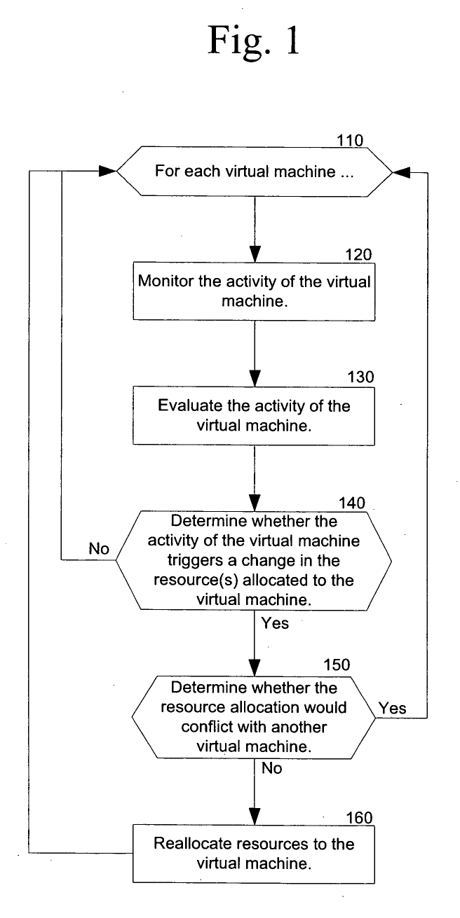

FIG. 1 is a flowchart illustrating an embodiment of a technique for reallocating resources amongst virtual machine(s) in accordance with the disclosed subject matter. Block 120 illustrates that the activity of the virtual machine (VM) may be monitored. In one embodiment, the virtual machine monitor (VMM) may monitor the VM. In one embodiment, activity such as, for example, processor usage, network usage, disk usage, or whether the VM is performing a time-critical task; however, these are merely a few non-limiting examples by which the disclosed subject matter is not limited.

In one embodiment, the activity may be monitored substantially in parallel with the execution of the VM. It is contemplated that the activity monitoring may be accomplished in hardware, software, firmware, or a combination thereof. In one embodiment, the activity may be monitored as the VM resource access is mapped to a real resource. In one embodiment, messages between the VM and the physical system may be caught and monitored by a virtual BIOS. In another embodiment, the messages between the VM and the physical system may be caught and monitored by a software application. In one embodiment, the VM activity may be monitored by a piece of logic in a processor core. Of course, these are merely a few illustrative examples to which the disclosed subject matter is not limited.

Block 130 illustrates that the activity may then be evaluated. In one embodiment, the monitored activity may be compared against the standard usage model for a generic VM. In another embodiment, the monitored activity may be examined to determine if it includes any time critical elements. In one embodiment, the monitored activity may indicate that the virtual machine is heavily using some resources but not others. Of course, these are merely a few non-limiting examples of how the monitored activity may be evaluated by which the disclosed subject matter is not limited.

Block 140 illustrates that it may be determined whether or not the activity of the VM triggers a change in the allocation of the resources used by the virtual machine. In one illustrative embodiment, a VM may be primarily using processor resources. For example the VM may be calculating data, or sorting lists. It may be determined that the amount of access the VM has to the processor is insufficient, and the VM would benefit from an increase to access to the physical processor. In a second illustrative embodiment, the VM may still be primarily using processor resources, but an increase in access to the physical processor resource would not significantly increase the performance of the VM. In this embodiment, as illustrated by Block 110, the technique illustrated by FIG. 1 may be performed on the next VM, or if only one VM is running in the system, repeated on the same VM.

It is contemplated that, while the VM may have access to many resources, the number of resources that may be adjusted or reallocated to the VM may be less than the total resources available to the VM. For example, in one embodiment, only the amount of time the host system is able to execute the VM may be able to be reallocated. In other embodiments, access to particular resources, such as, for example, the processor, the network interface, the hard drive, may be reallocated. In another embodiment, the ordering, in the case where VMs are executed in a round-robin fashion, or priority of the VMs may be rearranged in order to improve the performance of one or more VMs. For example, if a VM enters a state where it must accomplish a tack immediately, such as, for example, reporting system status or bringing up a another VM, the VM may be moved out of its normal position in the round-robin scheme and set to execute as quickly as possible in order to properly accomplish its task. In yet another embodiment, block 140 may reallocate or establish that, in a multi-processor, or multi-core environment, a certain VM has processor or core affinity with a particular processor or core, respectively. Some Operating System's have system calls for binding a process to a particular processor or core. The kernel ensures that when the process is re-scheduled it will be run on that processor/core and ideally, performance will be improved. It is contemplated that a particular embodiment may utilize one or more of these reallocation techniques described above, and the techniques are not to be considered mutually exclusive. Furthermore, the disclosed subject matter is not limited to the few illustrative examples discussed above and other resource allocation techniques are contemplated and within the scope of the disclosed subject matter.

Block 150 illustrates that, in one embodiment, if the determined resource reallocation would conflict with another virtual machine it may or may not be executed. For example, if two VMs are both network-bound, i.e. limited by amount of data it receives or transmits via the network, it may not be possible to reallocate enough resources to the first VM without decreasing the performance of the second VM. In one embodiment, illustrated by FIG. 1, if the reallocation can not occur, no reallocation may be attempted and the technique may be repeated on the next virtual machine, as illustrated by Block 110. In another embodiment, a database detailing the resource needs of each VM may be kept. If the suggested resource allocation is not possible, a new resource allocation may be fashioned utilizing the database. However, these are merely two example embodiments and other embodiments are within the scope of the disclosed subject matter.

Block 160 illustrates that the resources may be reallocated to the VM. In one specific embodiment, if a first VM is processor-bound and a second VM is network-bound, additional processor time or access may be allocated to the first VM and additional network interface time or access may be allocated to the second VM. Conversely, the processor time of the second VM may be decreased and the network interface access to the first VM may likewise be decreased. Of course, this is merely an illustrative example to which the disclosed matter is not limited.

In one embodiment, the technique of FIG. 1, in whole or part, may be executed on each VM in a serial fashion as illustrated by Block 110. In other embodiments, it is contemplated that the technique may be executed on each VM in parallel. It is further contemplated that some embodiments may execute a portion of the technique in parallel and a portion in serial.

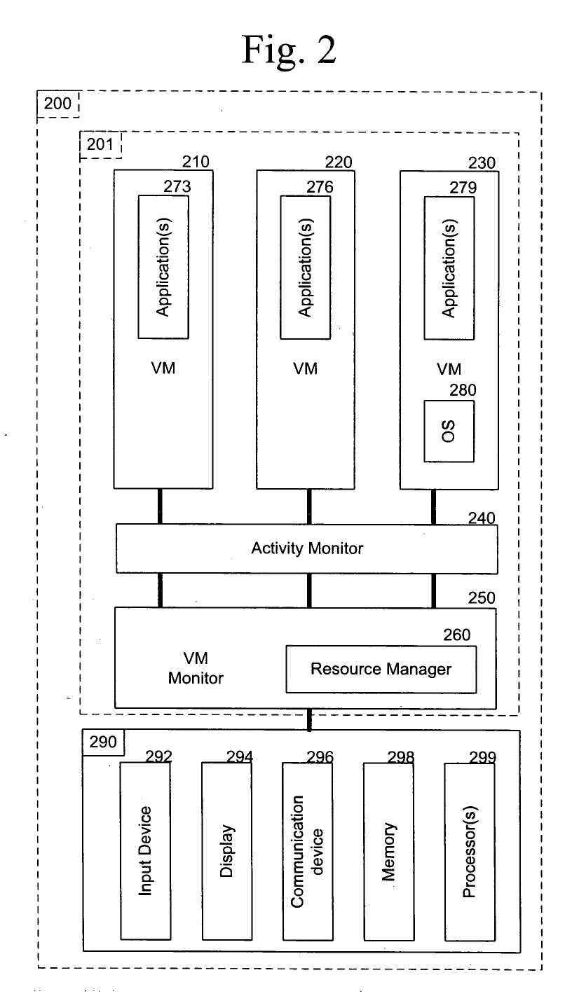

FIG. 2 is a block diagram illustrating an embodiment of a system 200 and apparatus 201 that allows for management of virtual machine(s) using information regarding the activity of the virtual machine(s) in accordance with the disclosed subject matter. In one embodiment, the apparatus may include a plurality of virtual machines 210, 220 & 230, and activity monitor 240, a virtual machine monitor (VMM) 250, and a resource manager 260. It is understood that while three virtual machines are illustrated in FIG. 2 the apparatus may include any number of virtual machines.

In one embodiment, the virtual machines 210, 220 & 230 may be capable of running an operating system 280 and a variety of applications 273, 276, & 279. It is contemplated that two or more virtual machines may share an operating system or applications. It is also contemplated that the virtual machines may also be capable of using a plurality of virtual resources that are mapped to physical resources. The activity monitor 240 may be capable of monitoring the activity of the virtual machines. In one embodiment, the activity monitor may be capable of performing a portion of the technique described above and illustrated by FIG. 1. It is contemplated that the activity monitor may be embodied in hardware, firmware, software, or a combination thereof.

In one embodiment, the VMM 250 may be capable of mapping the virtual resources utilized by the plurality of virtual machines to physical resources. The VMM may also be capable of managing the virtual machines access to the physical resources of the system. In one embodiment, the VMM may also include a resource manager 260 that is capable of reallocating the resources allotted to the virtual machines. In one embodiment, the resource manager may be capable of performing the technique described above and illustrated by FIG. 1. It is contemplated that the activity monitor may be embodied in hardware, firmware, software, or a combination thereof.

The system 200 may include the apparatus 201 and a plurality of physical resources 290. In one embodiment, the plurality of physical resources may include an input device 292, such as, for example, a mouse, a keyboard, a touchpad, etc., a display 294, such as, for example, a cathode-ray-tube (CRT) or a liquid crystal display (LCD), a communication device 296, such as, for example, a network interface card or a modem, a memory element 298, and a processor 299. The plurality of virtual machines 210, 220, & 230 may be capable of sharing the plurality of physical resources. This may be accomplished by creating a virtual plurality of resources in each VM, and mapping the virtual resources to the physical resources.

The techniques described herein are not limited to any particular hardware or software configuration; they may find applicability in any computing or processing environment. The techniques may be implemented in hardware, software, firmware or a combination thereof. The techniques may be implemented in programs executing on programmable machines such as mobile or stationary computers, personal digital assistants, and similar devices that each include a processor, a storage medium readable or accessible by the processor (including volatile and non-volatile memory and/or storage elements), at least one input device, and one or more output devices. Program code is applied to the data entered using the input device to perform the functions described and to generate output information. The output information may be applied to one or more output devices.

Each program may be implemented in a high level procedural or object oriented programming language to communicate with a processing system. However, programs may be implemented in assembly or machine language, if desired. In any case, the language may be compiled or interpreted.

Each such program may be stored on a storage medium or device, e.g. compact disk read only memory (CD-ROM), digital versatile disk (DVD), hard disk, firmware, non-volatile memory, magnetic disk or similar medium or device, that is readable by a general or special purpose programmable machine for configuring and operating the machine when the storage medium or device is read by the computer to perform the procedures described herein. The system may also be considered to be implemented as a machine-readable or accessible storage medium, configured with a program, where the storage medium so configured causes a machine to operate in a specific manner. Other embodiments are within the scope of the following claims.

While certain features of the disclosed subject matter have been illustrated and described herein, many modifications, substitutions, changes, and equivalents will now occur to those skilled in the art. It is, therefore, to be understood that the appended claims are intended to cover all such modifications and changes that fall within the true spirit of the disclosed subject matter.

1. A method comprising:
evaluating the activity of one or more virtual machines; and
reallocating physical resources to the virtual machine(s) based, at least in part, on the evaluated activity.

2. The method of claim 1, further including:
monitoring the activity of one or more virtual machines.

3. The method of claim 2, wherein monitoring the activity of one or more virtual machines includes monitoring an activity selected from a group including:
interrupt usage,
processor usage,
network usage,
disk usage, and
whether the virtual machine is performing a time-critical task.

4. The method of claim 2, wherein monitoring the activity of one or more virtual machines includes:
monitoring the activity of the virtual machine substantially in parallel with executing the virtual machine.

5. The method of claim 1, wherein reallocating physical resources to the virtual machine(s) based, at least in part, on the evaluated activity includes:
either increasing or decreasing the ability of the virtual machine(s) to access to a physical resource.

6. The method of claim 5, wherein reallocating physical resources to the virtual machine(s) includes:
increasing the ability of the virtual machine(s) to access to a first physical resource; and
decreasing the ability of the virtual machine(s) to access to a second physical resource.

7. The method of claim 5, wherein reallocating physical resources to the virtual machine(s) includes a reallocation selected from a group including the following:
altering the order in which the virtual machine(s) are executed,
swapping between virtual machines,
assigning core affinity to a virtual machine,
assigning a processor affinity to a virtual machine, and
altering the time quanta assigned to the virtual machine(s).

8. The method of claim 1, wherein reallocating physical resources to the virtual machine(s) is performed by a virtual machine monitor having a resource manager to evaluate the virtual machine(s) activity.

9. The method of claim 8, wherein the resource manager is a part of an integrated circuit.

10. The method of claim 1, wherein evaluating the activity of one or more virtual machines includes:
determining whether the activity of the virtual machine(s) is sufficient to trigger a change in the resource allocation;
suggesting a resource allocation; and
determining whether the suggested resource allocation negatively impacts the performance of another virtual machine.

11. An article comprising:
a storage medium having a plurality of machine accessible instructions, wherein when the instructions are executed, the instructions provide for:
evaluating the activity of one or more virtual machines; and
reallocating physical resources to the virtual machine(s) based, at least in part, on the evaluated activity.

12. The article of claim 11, further including instructions providing for:
monitoring the activity of one or more virtual machines.

13. The article of claim 12, wherein the instructions providing for monitoring the activity of one or more virtual machines includes instructions providing for monitoring an activity selecting from a group including:
interrupt usage,
processor usage,
network usage,
disk usage, and
whether the virtual machine is performing a time-critical task.

14. The article of claim 12, wherein the instructions providing for monitoring the activity of one or more virtual machines includes instructions providing for:
monitoring the activity of the virtual machine substantially in parallel with executing the virtual machine.

15. The article of claim 11, wherein the instructions providing for reallocating physical resources to the virtual machine(s) based, at least in part, on the evaluated activity includes instructions providing for:
either increasing or decreasing the ability of the virtual machine(s) to access to a physical resource.

16. The article of claim 15, wherein the instructions providing for reallocating physical resources to the virtual machine(s) includes instructions providing for:
increasing the ability of the virtual machine(s) to access to a first physical resource; and
decreasing the ability of the virtual machine(s) to access to a second physical resource.

17. The article of claim 15, wherein the instructions providing for reallocating physical resources to the virtual machine(s) includes a reallocation selected from a group including the following:
altering the order in which the virtual machine(s) are executed,
swapping between virtual machines,
assigning core affinity to a virtual machine,
assigning a processor affinity to a virtual machine, and
altering the time quanta assigned to the virtual machine(s).

18. The article of claim 11, wherein the instructions providing for reallocating physical resources to the virtual machine(s) are performed by a virtual machine monitor having a resource manager to evaluate the virtual machine(s) activity.

19. The article of claim 18, wherein the resource manager is a part of an integrated circuit.

20. The article of claim 11, wherein the instructions providing for evaluating the activity of one or more virtual machines includes instructions providing for:
determining whether the activity of the virtual machine(s) is sufficient to trigger a change in the resource allocation;
suggesting a resource allocation; and
determining whether the suggested resource allocation negatively impacts the performance of another virtual machine.

21. An apparatus comprising:
a plurality of virtual machines, capable of sharing a plurality of physical resources;
an activity monitor, capable of monitoring the activity of the virtual machines;
a virtual machine manager, capable of managing the virtual machines and reallocating access to the physical resources amongst the virtual machines, based at least in part on the monitored activity.

22. The apparatus of claim 21, wherein the virtual machine monitor includes a resource manager that is capable of reallocating access to the physical resources amongst the virtual machines.

23. The apparatus of claim 21, wherein the activity monitor is capable of monitoring an activity selected from a group including:
interrupt usage,
processor usage,
network usage,
disk usage, and
whether the virtual machine is performing a time-critical task.

24. The apparatus of claim 23, wherein the activity monitor is capable of monitoring the activity of the virtual machines substantially in parallel with the execution the virtual machines.

25. The apparatus of claim 21, wherein the virtual machine monitor is capable of either increasing or decreasing the ability of the virtual machine(s) to access to a physical resource.

26. The apparatus of claim 25, wherein the virtual machine monitor is capable of reallocating physical resources to the virtual machine(s) via:
increasing the ability of the virtual machine(s) to access to a first physical resource; and
decreasing the ability of the virtual machine(s) to access to a second physical resource.

27. The apparatus of claim 25, wherein the virtual machine monitor is capable of reallocating physical resources to the virtual machine(s) by selecting from a group including the following:
altering the order in which the virtual machine(s) are executed,
swapping between virtual machines,
assigning core affinity to a virtual machine,
assigning a processor affinity to a virtual machine, and
altering the time quanta assigned to the virtual machine(s).

28. The apparatus of claim 22, wherein the resource manager is further capable of evaluating the monitored activity of the virtual machine(s).

29. The apparatus of claim 28, wherein the resource manager is capable of evaluating the monitored activity of the virtual machine by:
wherein evaluating the activity of one or more virtual machines includes:
determining whether the activity of the virtual machine(s) is sufficient to trigger a change in the resource allocation;
suggesting a resource allocation; and
determining whether the suggested resource allocation negatively impacts the performance of another virtual machine.

30. The apparatus of claim 29, wherein the activity monitor and virtual machine monitor are integrated into the same circuit.

31. A system comprising:
a plurality of resources, having a processor and a network interface;
a plurality of virtual machines, capable of sharing access to the plurality of physical resources;
an activity monitor, capable of monitoring the activity of the virtual machines;
a virtual machine manager, capable of managing the virtual machines and reallocating access to the physical resources amongst the virtual machines, based at least in part on the monitored activity.

32. The system of claim 31, wherein the virtual machine monitor includes a resource manager that is capable of reallocating access to the physical resources amongst the virtual machines.

33. The system of claim 31, wherein the activity monitor is capable of monitoring an activity selected from a group including:
interrupt usage,
processor usage,
network usage,
disk usage, and
whether the virtual machine is performing a time-critical task.

34. The system of claim 33, wherein the activity monitor is capable of monitoring the activity of the virtual machines substantially in parallel with the execution the virtual machines.

35. The system of claim 31, wherein the virtual machine monitor is capable of either increasing or decreasing the ability of the virtual machine(s) to access to a physical resource.

36. The system of claim 35, wherein the virtual machine monitor is capable of reallocating physical resources to the virtual machine(s) via:
increasing the ability of the virtual machine(s) to access to a first physical resource; and
decreasing the ability of the virtual machine(s) to access to a second physical resource.

37. The system of claim 35, wherein the virtual machine monitor is capable of reallocating physical resources to the virtual machine(s) by selecting from a group including the following:
altering the order in which the virtual machine(s) are executed,
swapping between virtual machines,
assigning core affinity to a virtual machine,
assigning a processor affinity to a virtual machine, and
altering the time quanta assigned to the virtual machine(s).

38. The system of claim 32, wherein the resource manager is further capable of evaluating the monitored activity of the virtual machine(s).

39. The system of claim 38, wherein the resource manager is capable of evaluating the monitored activity of the virtual machine by:
wherein evaluating the activity of one or more virtual machines includes:
determining whether the activity of the virtual machine(s) is sufficient to trigger a change in the resource allocation;
suggesting a resource allocation; and
determining whether the suggested resource allocation negatively impacts the performance of another virtual machine.

40. The system of claim 39, wherein the activity monitor and virtual machine monitor are integrated into the same circuit.
